(19) United States
(12) Patent Application Publication
(10) Pub. No.: US 2021/0158843 A1
(43) Pub. Date: May 27, 2021

(54) MOBILE APPLICATION FOR FUTURE INTERACTION

(71) Applicants: Shabazz Lalumba Graham, London (GB); Olawale Oluwadamilere Omotayo Dada, London (GB)

(72) Inventors: Shabazz Lalumba Graham, London (GB); Olawale Oluwadamilere Omotayo Dada, London (GB)

(21) Appl. No.: 17/164,852

(22) Filed: Feb. 2, 2021

(51) Int. Cl. G11B 27/036; H04N 5/91; G06F 3/0484

(52) U.S. Cl. CPC G11B 27/036; G06F 3/0484; H04N 5/91

(57) ABSTRACT

A future thinking mobile application, which may allow one or more users to interact with their loved ones as if it is happening in real time is presented. The application may allow or enable a user to record one or more circular images or videos. The application may further facilitate to have a series of prerecorded video or audio questions that can be loaded into the application. This can be used by the user to conduct own personal interviews. The application may further ensure a delivery of multiple digital content to respective recipients when the user is inactive in the application for a defined time duration. The application may further facilitate a circular media player which layouts media content in an orbital fashion. The application may further enable or allow the user to add voice or audio components to a static image.

### FIELD OF INVENTION

Various embodiments of the disclosure relate generally to a mobile application. More specifically, various embodiments of the disclosure relate to a future thinking mobile application, which may allow the users to interact with their loved ones as if it is happening in real time.

### BACKGROUND

The number of social media platforms with which users interact has proliferated over the past few years. Examples of such social media platforms include social networking systems (e.g., Facebook), professional networking systems (e.g., LinkedIn), virtual world platforms (e.g., Second Life), messaging systems (e.g., Google email (Gmail), Google Wave, Skype), blogging systems (e.g., Blogspot.com), and review/rating systems (e.g., Yelp.com, Digg.com). Social networking platforms are continuing to gain popularity as platforms on which users interact, communicate, and share using multiple types of data and communication channels. For example, a number of social networking platforms provide one or more messaging tools, and photo and video sharing capabilities. These social networking platforms also allow users to share content located on the internet with each other in a convenient manner and provide mechanisms by which users can exercise control over with whom they share information, and what information is shared with them (e.g., by source or by content type).

With the increasing popularity of social media, many users entrust committing their life story to their current user profiles on one or more social media sites. However, social media presents too many obstacles to protecting one's personal information from being shared with unintended recipients. With the advent of smartphones, tablets, and other digital content recording devices, the creation of personal digital content is moving at a pace never experienced before. Generally, a user can share thoughts, messages, audio, video, or other digital content on the social media that may be viewed or accessed by the user's friend, friends of friends, and so on. However, it is difficult for the user to create and store meaningful queries intended for one or more targeted recipients that can be accessed by the targeted recipients only at some point of time in the future using the existing social media sites. Though the existing social media do facilitate a private chat box where the user can create and share private thoughts, messages, or other digital content with another user. This social media facility does not allow the user to create a digital query with multiple questions that are embedded together. In addition, the current social media does not allow the recipient to actually record his or her answer against each question in the same digital query loop. Thus, in light of the foregoing, there exists a need for a technical and reliable solution that overcomes the above-mentioned problems, challenges, and short-comings, and provides a new and enhanced social media platform that continues to facilitate effective and efficient user experience to its users.

### SUMMARY

It is an object of the present disclosure to provide a future thinking mobile application, which may allow one or more users to speak to their future today. The mobile application may allow the users to interact with their loved ones as if it is happening in real time. The mobile application may be configured to allow or enable a user to record one or more circular images or videos. The mobile application may be further configured to facilitate to have a series of prerecorded video or audio questions (covering recording and editing) that can be loaded into the application. This can be used by the user to conduct own personal interviews. The mobile application may be further configured to ensure a delivery of multiple digital content to their respective recipients when the user is inactive in the application for a defined time duration. The mobile application may be further configured to facilitate a circular media player which layouts media content in an orbital fashion. The mobile application may be further configured to enable or allow the user to add voice or audio component to a static image.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The invention is explained in further detail, and by way of example, with reference to the accompanying drawings wherein:

FIG. 1 is a block diagram that illustrates a system environment in which various operations of a mobile application for a social media platform of the present invention are practiced;

FIGS. 2A and 2B are diagrams that illustrate various graphical user interfaces for presenting various modes of an in-app question camera (Qcam) of the mobile application, in accordance with an exemplary embodiment of the disclosure;

FIG. 3 is a diagram that illustrates a graphical user interface for recording a series of questions, in accordance with an exemplary embodiment of the disclosure;

FIG. 4 is a diagram that illustrates a graphical user interface for editing and reviewing a recorded Qcast, in accordance with an exemplary embodiment of the disclosure;

FIGS. 5A, 5B, 5C, and 5D are diagrams that illustrate a series of graphical user interfaces for creating a Qcast interview, in accordance with an exemplary embodiment of the disclosure;

FIG. 6 is a diagram that illustrates a graphical user interface for presenting an inactivity period launcher of the mobile application, in accordance with an exemplary embodiment of the disclosure;

FIG. 7 is a diagram that illustrates a graphical user interface for presenting a content posting feature, in accordance with an exemplary embodiment of the disclosure;

FIG. 8 is a diagram that illustrates a graphical user interface for presenting historical memories of a user, in accordance with an exemplary embodiment of the disclosure; and

FIG. 9 is a block diagram that illustrates a system architecture of a computer system for performing various operations of the mobile application, in accordance with an exemplary embodiment of the disclosure.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in an embodiment” or “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. In addition, as used herein, the term “or” is an inclusive “or” operator and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” may include singular or plural references. The meaning of “in” includes “in” and “on.”

The following is a description of illustrative embodiments that when taken in conjunction with the following drawings will demonstrate the above-noted features and advantages, as well as further ones. In the description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, tools, techniques, and methods are omitted so as not to obscure the description of the present system. It should be expressly understood that the drawings are included for illustrative purposes and do not represent the scope of the present system. In the accompanying drawings, like reference numbers in different drawings may designate similar elements.

As used herein, the phrase “social networking service” or “social networking website” refers to a service that builds and reflects on one or more social networks or social relationships among one or more users. The social network may, for example, be determined by schools attended, interests, activities, relationships, and/or geographic regions. Most social network services are web or mobile-based and provide a means for user interaction over the Internet. Social networking services are usually individual-centered and allow users to share ideas, activities, events, and interests with other users within their individual network. Examples of social networking websites include, but are not limited to, Facebook® brand social networking website, LinkedIn® brand business-oriented social networking website, Twitter® brand social networking and microblogging service, and Friendster® brand social networking website.

As used herein, the phrase “social media” includes one or more services that may utilize web technology or mobile technology or analogous technology that provides users with the ability to create and exchange user-generated content over the Internet. Hence, social media is typically defined as enabling a blending of technology and social interaction. Examples of social networking websites include Facebook® brand social networking website, LinkedIn® brand business oriented social networking website, Twitter® brand social networking and microblogging service, and Friendster® brand social networking website.

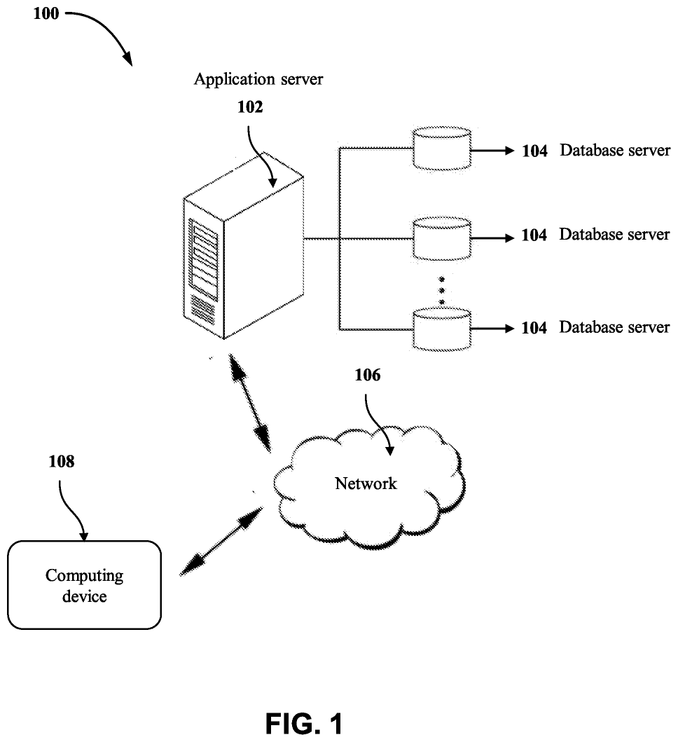

FIG. 1 is a block diagram that illustrates a system environment 100 in which various operations of a mobile application for a social media platform of the present invention are practiced. The system environment 100 includes one or more computing servers such as an application server 102, one or more database servers such as a database server 104, and one or more networks such as a network 106. The system environment 100 further includes one or more user computing devices associated with one or more users such as a user computing device 108 associated with a user. Examples of the user computing device 108 may include a smartphone, a tablet computer, a laptop, or any other portable communication device. The application server 102 and the user computing device 108 may communicate with each other over a communication network such as the network 106. The application server 102 and the database server 104 may also communicate with each other over the same network 106 or a different network.

The application server 102 is a computing device, a software framework, or a combination thereof, that may provide a generalized approach to create the application server implementation. Examples of the application server 102 include, but are not limited to, a personal computer, a laptop, or a network of computer systems. The application server 102 may be realized through various web-based technologies such as, but not limited to, a Java web-framework, a .NET framework, a PHP (Hypertext Preprocessor) framework, or any other web-application framework. The application server 102 may operate on one or more operating systems such as Windows, Android, Unix, Ubuntu, Mac OS, or the like. Various operations of the application server 102 may be dedicated to execution of procedures, such as, but are not limited to, programs, routines, or scripts stored in one or more memory units for supporting its applied applications and performing one or more operations.

In an embodiment, the application server 102 may be configured to facilitate the social media platform for performing one or more social media activities. The social media platform may be implemented, supported, and presented by the application server 102 on the one or more user computing devices such as the user computing device 108 and may be used by the one or more users for performing the one or more social media activities over the Internet. In an exemplary embodiment, the application server 102 may be configured to execute a computer program to implement one or more aspects of the social media platform. For example, the computer program may create and manage databases and data tables that store data used by the computer program. The computer program may include instructions for the application server 102 to execute in order to implement the methods and processes associated with various aspects of the present disclosure. The computer program may be tangibly embodied on a computer-readable medium such as a magnetic disk, a magneto-optical disk, a flash memory, a random-access memory, a read-only memory, a programmable read-only memory, an erasable programmable read-only memory, or the like. The computer program further permits each network user to create one or more digital content such as an audio or video file having a series of questions (such as at least 2 or more questions). The computer program further permits each network user to view, read, like, dislike, comment, and store one or more digital content (such as messages, images, videos, or the like) that may have been posted or shared or created by other users on the same social media platform.

In an exemplary embodiment, the application server 102 may be configured to implement, support, and present an application (in the form of mobile or web-based application) for the social media platform on the one or more user-computing devices by executing the computer program. The mobile application, as implemented, supported, and presented by the application serve 102, may then allow the users to interact with their loved ones as if it is happening in real-time. For example, the mobile application may be configured to allow or enable a user to record one or more multimedia files in one or more formats such as circular image, audio, or video files. The mobile application may be further configured to facilitate a series of prerecorded image, video, or audio questions or queries or messages that can be loaded into the application. These prerecorded questions or queries or messages may be used as a sample by the user to create a multimedia file (i.e., a new Qcast) having at least two or more questions or queries or messages in a selected format such as portrait format or circular format. This can be used by the user to conduct his own personal interviews. Each multimedia file may be recorded in one go and may include a plurality of media files (such as in the form of audio, video, or text messages, or any combination thereof) corresponding to a plurality of questions or queries or messages such that one media file is separated from another media file by a defined time duration but both media files are part of the same multimedia file. The mobile application may be further configured to enable or allow the user to review and edit the created media files of the multimedia file. The mobile application may be further configured to allow or enable a recipient of the multimedia file to actually record his or her answer or response message against each question in each media file in the same digital query loop. The mobile application may be further configured to ensure a delivery of multiple multimedia files to their respective recipients when the user is inactive in the application for a defined time duration. The mobile application may be further configured to facilitate a circular media player which layouts the media files in an orbital fashion. The mobile application may be further configured to enable or allow the user to add voice or audio component to a static image. The mobile application may be further configured to enable or allow the user to upload one or more photographs from a device library, from a cloud server, from other Qcasts, or simply take one or more photographs using the Qcam. The mobile application may be further configured to enable or allow the user to embed or add a short voice note or annotation to each photograph. Once saved within the application, the voice annotation may be played when that photograph or annograph is selected. The mobile application may be further configured to provide a carousel media player that is a circular styled media player which layouts media files within each Qcast in an orbital fashion, with small circles positioned around a central large circle such that each small circle corresponds to a media file corresponding to a Qcast question. When one of the smaller circles of the media files is selected, then its content appears automatically within the large central circle. When the large central circle is selected by the user, then the corresponding media popups and plays automatically. Although an alternative ‘Grid’ may also be available to the user to view the content through, this will be the default media player for all media. Further, the assigned Qcasts are digital time capsules (spheres) which the user creates and assigns to well-deserved recipients, such as family, friends, mentor, mentee, or anyone else. When creating a new assigned Qcast, the user only requires an email address of the person who is the potential recipient. This ensures that the Qcast may be sent to them once the inactivity period is triggered.

In addition, the application server 102 may be further configured to implement an augmented reality scanner and filter feature. There may be an in-built camera with the mobile application, that is generally referred to as the Qcam, which may be able to load personalized items and assets, that have been scanned-in by the platform in 3D, ready to be uploaded into a real time video recording, within the mobile application. The application server 102 may be further configured to implement or incorporate an API feature that siphons into assigned online content images in which recipients feature. The application server 102 may be further configured to develop or generate themes, which will be stylized templates that the users may load to enhance and personalize their assigned multimedia. These theme packages may enable the users to customize and make multimedia more relevant and personal for each of their assigned multimedia recipients. Each theme may have a different purpose that facilitates a variety of intentions and goals the users have for their assigned recipients. Examples of theme type may include, but are not limited to, “mother to Son”, “Grandfather to Granddaughter”, or “Mentor to Mentee”. The basic title and structure of the theme may be composed around the relationship of the sender (a user who assigns the multimedia) to the recipient (a user who receives the assigned multimedia). The mentor to mentee theme, for example, may assist the users in turning their values and principles into a treasured series of mentorship styled films and content to motivate and provide guidance for their recipients. This may be ideal for people with experience and pearls of wisdom they wish to share and pass on to mentees/students, family members and friends. The application server 102 may be further configured to allow a user who may be able to add-on a ‘Will Presenter’ function. This add-on will be perfect for the users who either have or are in the process of beginning a Legal Will. Once approved and cosigned by the User's solicitor and/or executor, the Will Presenter function turns multimedia into a personal ‘Will Composer’ and ‘Presenter’, allowing the users the opportunity to record a video, or a series of video messages, that will be presented to their beneficiaries at the traditional reading of their Legal Will and inheritance. This function may transform the way beneficiaries receive their inheritance, changing it from the traditional ‘Will reading’ into a more advanced ‘Will Presenter’ presentation. Further, the user may be able to add-on the Public Domain function. This add-on is tailor made for the users with a social media following, channel, and/or subscribers. This add-on has a ‘public-facing’ option which allows the users to prepare and share their time posts with multiple amounts of multimedia recipients at once.

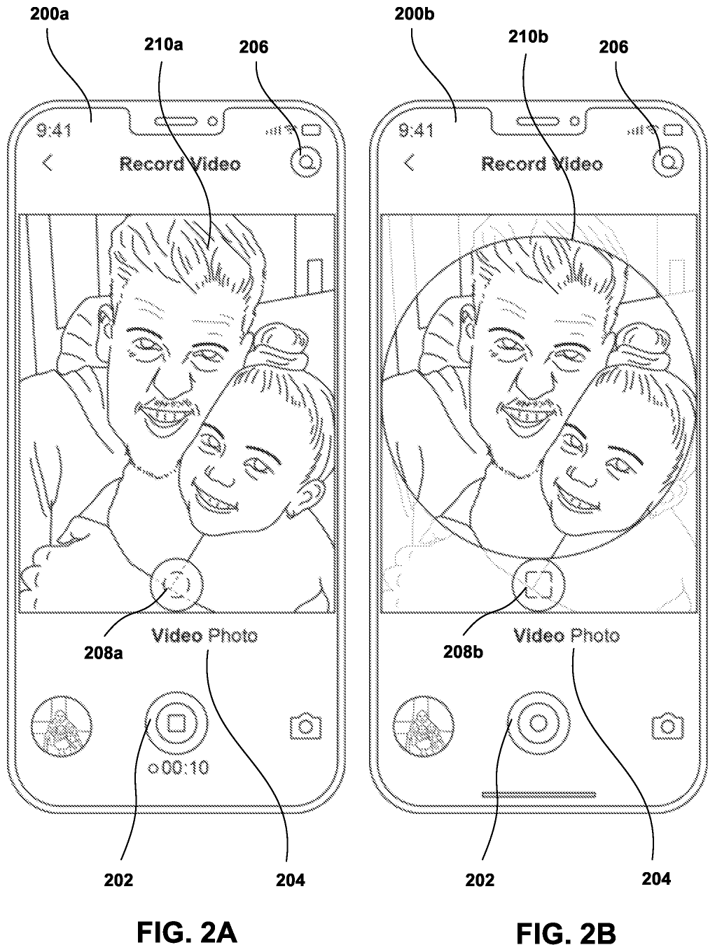

Various other operations of the mobile application, as implemented, supported, and presented by the application serve 102, have been described in detail in conjunction with FIGS. 2-9.

The database server 104 may include suitable logic, circuitry, interfaces, and/or code, executable by the circuitry that may be configured to perform one or more data management and storage operations such as receiving, storing, processing, and transmitting queries, data, content, algorithms, code, or the like. In an embodiment, the database server 104 may be a data management and storage computing device that is communicatively coupled to the application server 102 or the user computing device 108 via the network 106 to perform the one or more operations. In an exemplary embodiment, the database server 104 may be configured to manage and store one or more profiles of the one or more users who are registered on the social media platform. Each profile may include information such as a user's name, number, email, preferences, followers, followings, or the like. In an exemplary embodiment, the database server 104 may be further configured to manage and store multimedia data, texts, images, videos, or the like that were created, liked, disliked, shared, or commented by the one or more users on the social media platform. In an exemplary embodiment, the database server 104 may be further configured to manage and store one or more algorithms, rules, code, or the like that are retrieved and executed by the application server 102 to perform the one or more designated operations in the real time. In an exemplary embodiment, the database server 104 may be further configured to manage and store one or more notifications. In an embodiment, the database server 104 may be further configured to receive a query from the application server 102 for retrieval of the stored information. Based on the received query, the database server 104 may communicate the requested information to the application server 102. The database server 104 may be implemented by means of a personal computer, a laptop, or a network of computer systems. Examples of the database server 104 may include, but are not limited to, MongoDB, Cassandra, and HBase, or Structured Query Language (SQL) database.

The network 106 may include suitable logic, circuitry, interfaces, and/or code, executable by the circuitry that may be configured to transmit messages and requests between various entities, such as the application server 102, the database server 104, and the user computing device 108. Examples of the network 106 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 100 may connect to the network 106 in accordance with various wired and wireless communication protocols, such as Transmission Control Protocol and Internet Protocol (TCP/IP), User Datagram Protocol (UDP), Long Term Evolution (LTE) communication protocols, or any combination thereof.

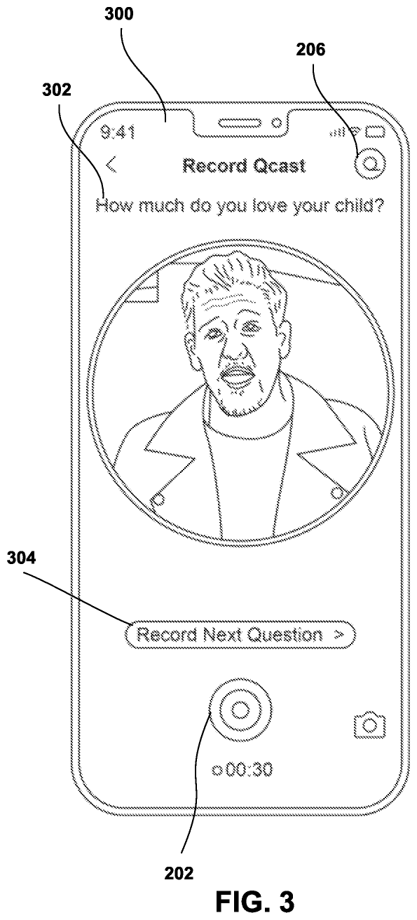

FIGS. 2A and 2B are diagrams that illustrate various graphical user interfaces 200a and 200b for presenting various modes of an in-app question camera (Qcam) of the mobile application, in accordance with an exemplary embodiment of the disclosure. The in-app Qcam is a feature of the mobile application that work in conjunction with a mobile camera of a mobile device. The Qcam is an abbreviation of ‘Question Camera’ and is an in-built camera features within the mobile application. The Qcam may be configured with a plurality of selectable options such as a record or capture tab 202, a video or photo mode 204, a Qcast mode 206, a circular frame switching mode 208a, and a portrait frame switching mode 208b, as shown in FIGS. 2A and 2B. In an exemplary embodiment, the record or capture tab 202 may be selected or tapped by a user to either start recording of a video or start capturing of a still image. In an exemplary embodiment, the video or photo mode 204 may be selected by a user to either record a video or capture a still image. In an exemplary embodiment, the Qcast mode (‘Q’ icon 206 in the top right-hand corner of the graphical user interface 200a or 200b) may be selected by a user to switch the Qcam from a standard mode to a Qcast mode in which the user may be able to create a new multimedia file (i.e., a new Qcast). The multimedia file (or the new Qcast) may include a series of questions or queries or messages (at least two or more) in a circular video format FIG. 3, which is the default Qcast format. Each multimedia file may be recorded in one go recording the circular video media file corresponding to a plurality of questions or queries or messages such that one media file is separated from another media file but both media files are part of the same multimedia file. Thus, the multimedia file (created in the Qcast mode) may include the plurality of media files and each media file is configured with a fixed time duration, for example, 30 seconds. Post the completion of the fixed time duration, another media file may be recorded.

In an embodiment, the Qcam is provided with unique features and is configured to include one or more autocue text prompts (i.e., queries or questions or messages) that may be referred to by the user while creating the multimedia file in the Qcast mode. Further, as discussed above, the Qcam is configured to include the portrait frame mode 208b for facilitating portrait video recording and photo capturing. The Qcam is further configured to include the circular frame mode 208b for facilitating circular video recording and photo capturing. Further, the Qcam is configured to include exclusive multimedia intermittent recording and playback options.

In an embodiment, the user may record video footage in default portrait or landscape formats, and also in an exclusive circular format, by pressing the on-screen reframe button 208a or 208b, at the bottom of the camera's viewfinder, to switch between formats. Further, by clicking on the ‘Q’ icon (as shown by 206), in the top right-hand corner of the graphical user interface 200a or 200b, the Qcam is switched from the standard mode to the Qcast mode in which the user may be able to create a create the new Qcast i.e., the multimedia file having the plurality of media files corresponding to the plurality of queries or questions or messages.

FIG. 3 is a diagram that illustrates a graphical user interface 300 for recording a series of questions, in accordance with an exemplary embodiment of the disclosure. In an exemplary embodiment, the series of questions (i.e., the new Qcast) may be created when the user clicks on the “Q” icon 206 on the previous graphical user interface 200a or 200b. Further, the new Qcast may be created by using the one or more autocue text prompts (i.e., prewritten text-based queries or questions or messages) that may be selected and loaded by the user while creating the new Qcast in the Qcast mode. This new Qcast may include a series of video questions or queries or messages, captured in the circular format, which can then be saved to a Sylo (i.e., a multimedia file having a plurality of Qcasts), uploaded to a website directory (a Qcast cloud i.e., a cloud server such as the database server 104) and/or distributed in order for other users to download into their Qcam to conduct his or her own personal Qcast interview.

In an exemplary embodiment, by clicking on the ‘Q’ icon 206 on the graphical user interface 300, once in the Qcast mode, the mobile application may take the user to a ‘Question’ screen, from where the user may be able to load into the Qcam a preset and/or customized text-based prompt (such as a question or prompt) which may be used as an autocue on-screen caption (as shown by 302 in FIG. 3) for the user who wishes to be guided as the user records the series of questions i.e., while creating the new Qcast. Once the autocue on-screen caption is loaded into the Qcam of the mobile application (as shown by 302 in FIG. 3), the user may start the recording of the new Qcast by clicking the record button 202 on the graphical user interface 300. In an exemplary embodiment, the mobile application is not configured to limit the number of questions or queries or messages (i.e., the media files) for creating the new Qcast (i.e., a multimedia file) by the user based on the number of autocue captions selected by the user. For example, if the user selects 5 questions or prompts as the autocue captions, then the new Qcast may include these 5 questions first, one after another in a new Qcast recording, but these 5 loaded questions or prompts may not limit the new Qcast recording to 5 questions only, as the user can continue the new Qcast recording after the 5 questions have finished being displayed. The remaining recording of the new Qcast may continue without the autocue captions displaying. In this example, the user may record up to a maximum of 12 sequential questions. In some embodiments, the Qcam may allow the user to record the new Qcast without referring to any prerecorded autocue captions. In such a case, the user does not have to go to the ‘question’ screen and thus may start the recording of the new Qcast by simply clicking the record button 202 on the graphical user interface 300. In this case, the user may record up to a maximum of 12 sequential questions. In an embodiment, each recorded Qcast is a new multimedia file having a series of media files corresponding to a series of questions or queries or messages. The series of media files are recorded in a continuous manner with a predefined delay between two media files. Thus, there is only one start operation and one stop operation during the creation of the new Qcast i.e., the new multimedia file having the series of media files corresponding to the series of questions or queries or messages.

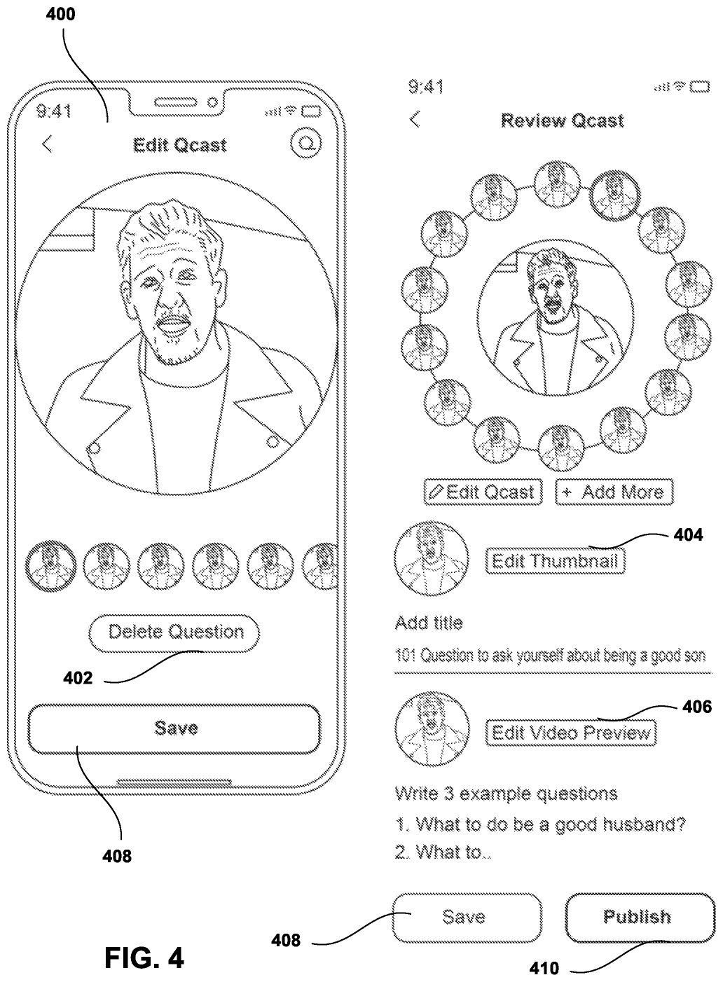

In an embodiment, the Qcast mode of the Qcam may be configured to enable or allow the user to record the new Qcast, which is a series of circular video questions or queries or messages, each lasting a maximum of a defined time duration, for example, 30 seconds long. Once the user has loaded a text prompt or question into the Qcam and presses the record button 202, in the Qcast mode as shown on the graphical user interface 300, a 5 second countdown appears on the screen, after which the 30 second recording of a first Qcast question begins. As the 30 second record time counts itself down, a circumference of the circular viewfinder highlights with a colored pulse such as a purple pulse, to give the user a clear visual guide of the recording time elapsed and the remaining time. The timecode beneath the record button 202 also displays the 30 second countdown and generally indicates the time remaining for completing the recording. Once the 30 second recording of the first Qcast question or query or message is complete, the 5 second countdown automatically reappears on the screen. The 30 second recording, with the 5 second countdowns may further automatically repeat for recording a second Qcast question until the user presses a stop button (same as the record button 202) to end the recording of the Qcast. In some embodiments, the user may click on a next question button 304 to record the second Qcast question and the process may continue until the user presses the stop button (same as the record button 202 or a separate button) to end the recording of the Qcast. Thereafter, the user may be taken to an edit screen as shown in FIG. 4.

FIG. 4 is a diagram that illustrates a graphical user interface 400 for editing and reviewing the recorded Qcast, in accordance with an exemplary embodiment of the disclosure. After the recording of the Qcast, the mobile application may be configured to provide a set of editing options that allow or enable the user to perform one or more editing operations. For example, a delete button 402 may be selected by the user to delete one or more unneeded questions. Further, a thumbnail button 404 may be selected by the user to edit a thumbnail associated with each question. Further, a preview button 406 may be selected by the user to see a preview of the video (i.e., the recorded Qcast). In addition, the user may also include exemplary questions by typing three example questions before they either save or publish the created Qcast by using a save button 408 or a publish button 410. The recorded Qcasts and Qcast interviews may be saved to the user's multimedia channel, in a ‘Saved Qcasts’ section. The user may also choose to publish the recorded multimedia directly to the public Qcast directory and social media platform Qcast cloud (a cloud server) for access and use by other users on the platform. The user may also choose to directly send the recorded multimedia directly to a Sylo of one of their particular assigned Sylo recipients.

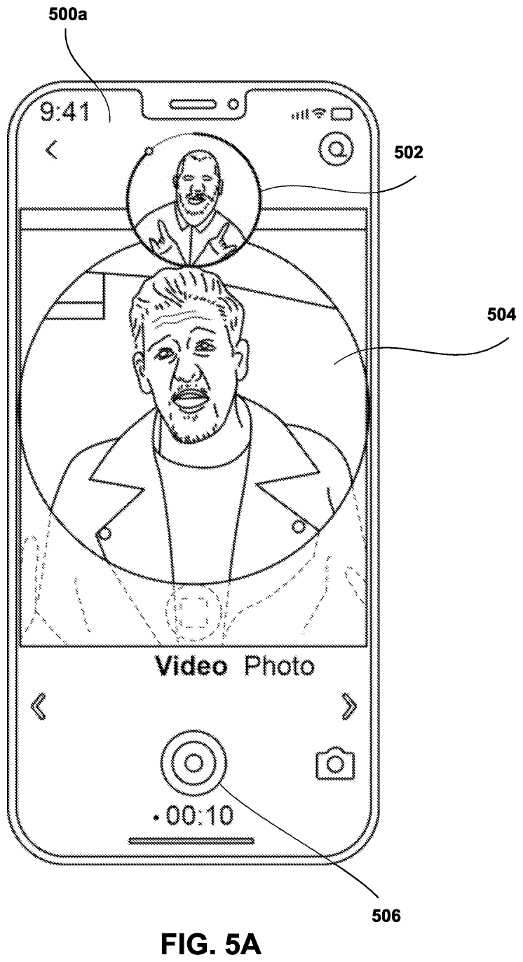

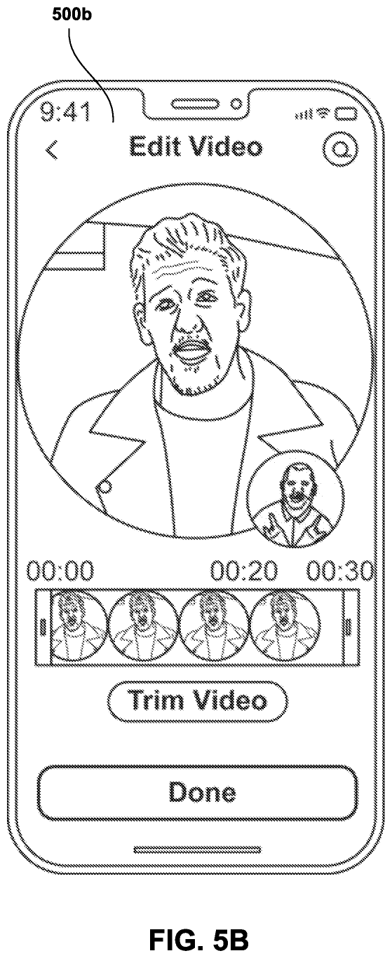

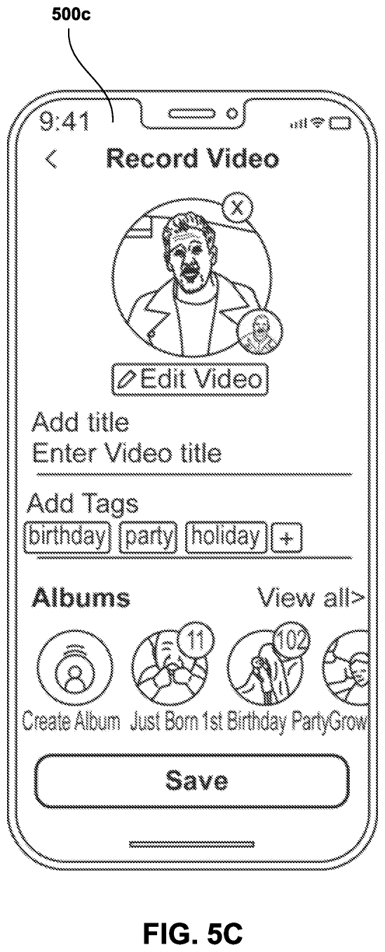

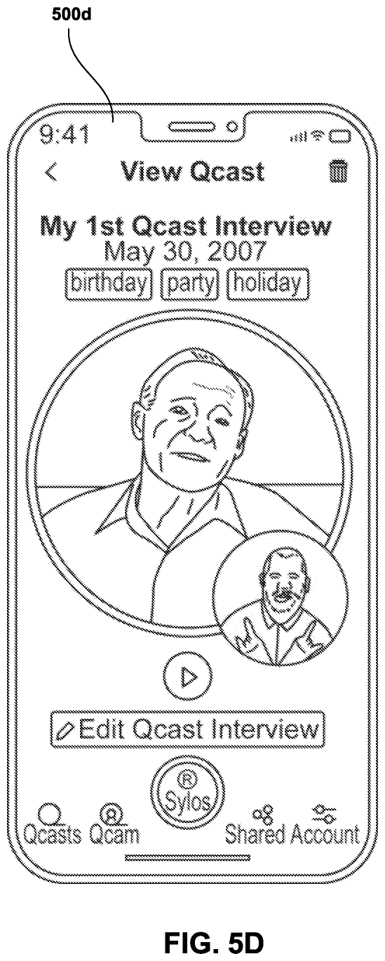

FIGS. 5A, 5B, 5C, and 5D are diagrams that illustrate a series of graphical user interfaces such as 500a, 500b, 500c, and 500d for creating a Qcast interview, in accordance with an exemplary embodiment of the disclosure. For example, when the recipient receives the recorded Qcast from the user, then the recipient may use the Qcam to respond to each of the Qcast questions in the received Qcast. The Qcam is the only place where the recipient can record the Qcast interview by responding to each of the Qcast questions in the received Qcast. The Qcast interview occurs only when the recipient loads the recorded Qcast (received from the user) into the Qcam in order to answer each of the questions posed in that Qcast. In an embodiment, during the process of the recording of the Qcast interview i.e., during the answering of each Qcast question in the Qcam mode, the mobile application may be configured to generate and present the graphical user interface 500a that includes at least two modules such as a first module 502 and a second module 504. The first module 502 may be configured to include a recorded media file including a Qcast question (say, the first media file including the first Qcast question) of the loaded Qcast and the second module 504 may be configured to include the recipient (who will answer the Qcast question) as seen from the Qcam of the mobile application. In an exemplary embodiment, the first module 502 and the second module 504 will be circular in shape and size of the first module 502 may be less than a size of the second module 504. When the recipient starts the recording by clicking on the record button 506, the first module 502 is activated to play the Qcast question whilst simultaneously the second module 504 begins recording ready to capture the user's answer (once the first module 502 finishes playing) corresponding to the Qcast question under the provision of the Qcam of the mobile application that works in conjunction with the device camera. Post the answering of the Qcast question (say, the first Qcast question), the mobile application may present another Qcast question (say, the second Qcast question) in the first module 502 which plays when the user selects the arrow key to load the next question and thereafter the recipient responds accordingly that is recorded by the Qcam. This process may continue until all of the Qcast questions of the loaded Qcast are answered by the recipient or the recipient manually halts the recording process by using the record button 506. Following the recording of the one or more answers corresponding to the one or more Qcast questions, the user may be able to edit, save, and/or publish their Qcast interview as shown in the graphical user interfaces 500b, 500c, and 500d. The recorded Qcast interviews may be saved to one or more of the user's assigned multimedia (may be referred to as Sylos). It might also be saved to the users Qcast channel, in a ‘Saved Qcasts’ section. The user may also choose to publish the recorded Qcast interview directly to a cloud server (such as the user's social media profile stored on the cloud server). The user may also choose to send the recorded Qcast interview directly to the user who initially sent them the Qcast, as way of answering their Qcast's questions.

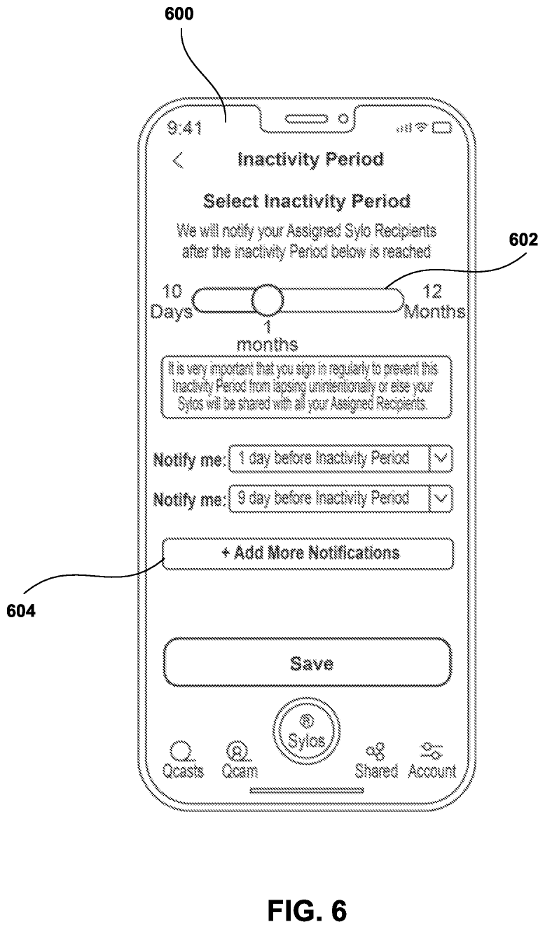

FIG. 6 is a diagram that illustrates a graphical user interface 600 for presenting an inactivity period launcher 602, in accordance with an exemplary embodiment of the disclosure. The inactivity period launcher 602 has been created to ensure that the user's one or more previously created multimedia (may be referred to as Sylos) may be delivered to their assigned recipients after expiry of a time duration set by the user. This multimedia may include Qcasts (that have not yet been delivered to its recipients) and Qcast interviews. For example, in the event of the user dying suddenly, the mobile application may deliver the user's one or more previously created multimedia (including the Qcasts and Qcast interviews) to their assigned recipients after expiry of the time duration set by the user. This feature may mitigate any possible risk of the user not being able to gift his or her recipients with their populated multimedia (i.e., the Sylos). For the user to set the inactivity period, the user may need only to enter the user's account, select the inactivity period by using the inactivity period launcher 602, and increase or reduce the time period dial to their preferred time (say, 1 month). Based on the expiry of the set inactivity period, the mobile application may deliver all created and stored multimedia (including the Qcasts and Qcast interviews) to all of the user's assigned recipients. Once the inactivity period lapses, all of the assigned recipients will be sent an email link for them to access the multimedia (including the Qcasts and Qcast interviews) created for them by the user. It may be further important that the user sign in regularly to prevent the set inactivity period from lapsing unintentionally, or else all their multimedia (including the Qcasts and Qcast interviews) may be shared with all their assigned recipients. The inactivity period notifications may be set by using an add notification button 604 and may be set to warn the user in the lead up to the final set date.

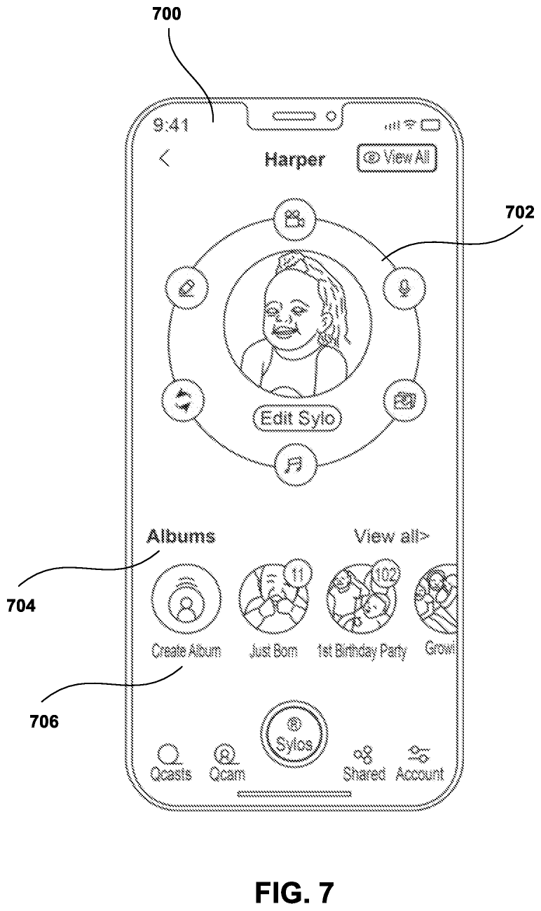

FIG. 7 is a diagram that illustrates a graphical user interface 700 for presenting a content posting feature, in accordance with an exemplary embodiment of the disclosure. The mobile application may be configured to provide a plurality of content creation modes 702 that may be utilized by the one or more users to record and link content to one or more assigned or new multimedia or Sylos. The various modes 702 may include a video mode to create a rectangle video recording post and a circular Qcast and Qcast Interview post (through the user entering the Qcast mode), an audio mode to create an audio recording post (which may be called ‘soundbites), an image mode to create a photograph post (which has the option of being embedded with a soundbite to update it to an ‘annograph’; meaning annotated photograph), a music mode to create a music-based post, and a text mode to create a text-based post. The graphical user interface 700 may also include an album section 704 that displays one or more previously created multimedia posts, including Qcasts and Qcast Interviews. The user may also create a new digital album by using a create album option 706.

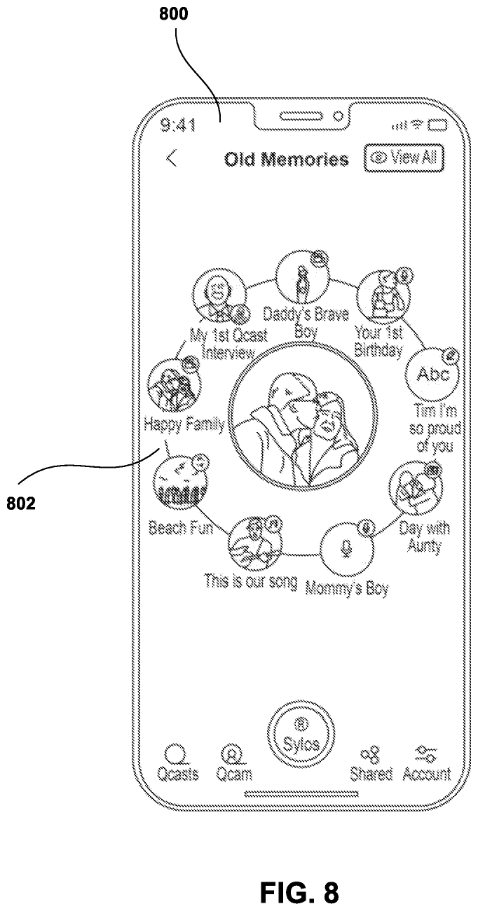

FIG. 8 is a diagram that illustrates a graphical user interface 800 for presenting historical memories 802 of the user, in accordance with an exemplary embodiment of the disclosure. The historical memories 802 may include one or more previously created Qcasts and/or received Qcasts. The mobile application may layout the historical Qcast 802 in an orbital fashion, with small circles positioned around a central large circle such that each small circle corresponds to a historical Qcast. When one of the smaller circles is selected, then its content appears automatically within the large central circle as shown. Further, when the large central circle is selected by the user, then the corresponding media popups and plays automatically.

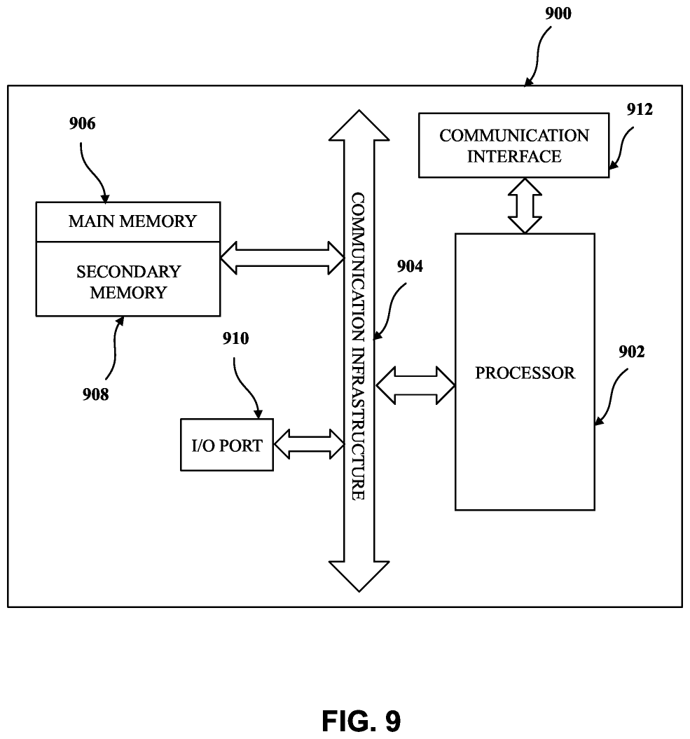

FIG. 9 is a block diagram that illustrates a system architecture of a computer system 1100 for performing various operations of the mobile application as described above. An embodiment of the present invention, or portions thereof, may be implemented as computer-readable code on the computer system 900. In one example, the application server 102 or the database server 104 of FIG. 1 may be implemented in the computer system 900 using hardware, software, firmware, non-transitory computer-readable media having instructions stored thereon, or a combination thereof and may be implemented in one or more computer systems or other processing systems. Hardware, software, or any combination thereof may embody modules and components used to implement the various operations illustrated in the present invention. The computer system 900 includes a processor 902 that may be a special purpose or a general-purpose processing device. The processor 902 may be a single processor, multiple processors, or combinations thereof. The processor 902 may have one or more processor “cores.” Further, the processor 902 may be connected to a communication infrastructure 904, such as a bus, a bridge, a message queue, the network 106, multicore message-passing scheme, and the like. The computer system 900 further includes a main memory 906 and a secondary memory 908. Examples of the main memory 906 may include RAM, ROM, and the like. The secondary memory 908 may include a hard disk drive or a removable storage drive (not shown), such as a floppy disk drive, a magnetic tape drive, a compact disk, an optical disk drive, a flash memory, and the like. Further, the removable storage drive may read from and/or write to a removable storage device in a manner known in the art. In an embodiment, the removable storage unit may be a non-transitory computer readable recording media. The computer system 900 further includes an input/output (I/O) port 910 and a communication interface 912. The I/O port 910 includes various input and output devices that are configured to communicate with the processor 902. Examples of the input devices may include a keyboard, a mouse, a joystick, a touchscreen, a microphone, and the like. Examples of the output devices may include a display screen, a speaker, headphones, and the like. The communication interface 912 may be configured to allow data to be transferred between the computer system 900 and various devices that are communicatively coupled to the computer system 900. Examples of the communication interface 912 may include a modem, a network interface, i.e., an Ethernet card, a communications port, and the like. Data transferred via the communication interface 912 may be signals, such as electronic, electromagnetic, optical, or other signals as will be apparent to a person skilled in the art. The signals may travel via a communications channel, such as the network 106, which may be configured to transmit the signals to the various devices that are communicatively coupled to the computer system 900. Examples of the communication channel may include, but not limited to, cable, fiber optics, a phone line, a cellular phone link, a radio frequency link, a wireless link, and the like. Computer program medium and computer usable medium may refer to memories, such as the main memory 906 and the secondary memory 908, which may be a semiconductor memory such as dynamic RAMs. These computer program mediums may provide data that enables the computer system 900 to implement the present invention. In an embodiment, the present invention is implemented using a computer implemented application. The computer implemented application may be stored in a computer program product and loaded into the computer system 900 using the removable storage drive or the hard disk drive in the secondary memory 908, the I/O port 910, or the communication interface 912.

A person of ordinary skill in the art will appreciate that embodiments and exemplary scenarios of the disclosed subject matter may be practiced with various computer system configurations, including multicore multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, a future thinking mobile application, which may allow the users to interact with their loved ones as if it is happening in real time. While various exemplary embodiments of the disclosed application have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. An application server, comprising: circuitry configured to implement and execute a mobile application on a user device, wherein the mobile application is configured to: enable a user to record one or more multimedia files in one or more formats; and facilitate a series of prerecorded image, video, or audio questions or queries that can be loaded into the application, wherein the prerecorded questions or queries is used as a sample by the user to create a multimedia file having at least a plurality of media files corresponding to a plurality of questions or queries such that one media file is separated from another media file by a defined time duration and all of the media files are part of the same multimedia file that are created together with one start recording operation and one stop recording operation.

2. The application server of claim 1, wherein the one or more formats comprise at least circular or portrait image, audio, or video files.

3. The application server of claim 1, wherein the mobile application is further configured to enable the user to review and edit the created media files of the multimedia file.

4. The application server of claim 1, wherein the mobile application is further configured to enable a recipient of the multimedia file to record an answer or response message against each question in each media file.

5. The application server of claim 4, wherein the mobile application is further configured to generate and present a graphical user interface that includes at least a first module and a second module, wherein the first module is configured to include a recorded media file corresponding to a first question and the second module is configured to include the recipient, who wishes to record an answer or response message against the first question.

6. The application server of claim 5, wherein the first module and the second module are circular or rectangular or square in shape and the size of the first module is less than the size of the second module.

7. The application server of claim 1, wherein the mobile application is further configured to ensure a delivery of multiple multimedia files to their respective recipients when the user is inactive in the application for a defined time duration.

8. The application server of claim 1, wherein the mobile application is further configured to facilitate a circular media player which layouts the media files of the multimedia file in an orbital fashion.

9. The application server of claim 1, wherein the mobile application is further configured to enable the user to add voice or audio component to an image.

10. The application server of claim 1, wherein the mobile application is further configured to enable the user to upload one or more photographs from a device library or from a cloud server.

11. The application server of claim 1, wherein the mobile application is further configured to enable the user to upload the one or more photographs by taking the one or more photographs using the device's camera in conjunction with the mobile application.

12. The application server of claim 11, wherein the mobile application is further configured to enable the user to embed or add a voice annotation to each photograph.

13. The application server of claim 12, wherein the voice annotation is played when that photograph or annotation is selected by the user.

14. The application server of claim 1, wherein the mobile application is further configured to provide a media player that is a circular styled media player which layouts the media files within each multimedia file in an orbital fashion, with small circles positioned around a central large circle such that each small circle corresponds to a media file corresponding to a question.

15. The application server of claim 14, wherein, when one of the smaller circles of the media files is selected, then its content appears automatically within the large central circle.

16. The application server of claim 15, wherein, when the large central circle is selected by the user, then the corresponding media popups and plays automatically.
